(19) United States
(12) Patent Application Publication
(10) Pub. No.: US 2001/0034743 A1
(43) Pub. Date: Oct. 25, 2001

(54) Method and apparatus for creating relocatable internet web sites

(76) Inventor: Edwin Thomas, Portland, OR (US)

Correspondence Address: STOEL RIVES LLP, 900 SW FIFTH AVENUE, SUITE 2600, PORTLAND, OR, 97204, US

(21) Appl. No.: 09/765,109

(22) Filed: Jan. 16, 2001

Related U.S. Application Data
(60) Provisional application No. 60/176,330, filed on Jan. 14, 2000.

(51) Int. Cl. G06F 17/24

(52) U.S. Cl. 707/501.1; 707/530

(57) ABSTRACT

The present invention relates to the field of redefining absolute references in a Web site so as to make the Web site and its referenced content portable and installing the portable Web site on a system within the mezzanine of the Internet so as to make the information available to a user from a more proximate location. To take advantage of the unused capacity of mezzanine systems, the present invention incorporates a systematic, organized, and highly structured, yet customizable, procedure for optimizing deployment of data from a remote primary server to any platform or location from which the data would be most optimally accessed. This is accomplished by globally replacing Web site source references with tokens. The tokens are then instantiated on install time and resolved specific to the target platform.

### RELATED APPLICATIONS

This application claims priority from U.S. Provisional Patent Application No. 60/176,330, filed Jan. 14, 2000.

### TECHNICAL FIELD

The present invention relates to the field of redefining absolute references in a Web site so as to make the Web site and its referenced content portable and installing the portable Web site on a system within the mezzanine of the Internet so as to make the information available to a user from a more proximate location.

### BACKGROUND OF THE INVENTION

The ability to readily convey information has made the Internet tremendously popular. In order to make information available to a wide variety of individuals in an easily accessible format, content is usually organized into Web pages (multiple Web pages being grouped together to comprise a Web site). These Web pages can then be viewed by remote users accessing the Internet with a Web browser program. However, the ability to convey certain types of information over networks such as the Internet has its limitations. While information conveyed on Web pages can readily include textual content, delivery of certain types of content, such as multimedia presentations, typically has been very slow and has resulted in poor-quality transmissions.

Primary factors contributing to the ineffective delivery of robust content over the Internet include problems with latency, bandwidth limitations, network congestion, and overwhelming amounts of network traffic attempting to access a particular Web site. Also, because individuals access the Internet using a wide variety of computer systems, each with a potentially different configuration, those wishing to provide content over the Internet must overcome difficulties with integration costs and scalability in order to customize the delivery for a specific user or target platform.

While problems with latency can be attributed to limitations in the Internet Protocol itself, many other problems affecting the distribution of content over the Internet can be attributed to limitations in the Internet's architectural paradigm. As it currently exists, the Internet comprises essentially two tiers. These two tiers are conceptually illustrated in FIG. 1. The first tier is that primarily comprising mainframes or remote Web servers 100. The second tier is that primarily comprising desktop computer systems 102. In between the Web servers 100 and the desktop systems 102 is a vast expanse referred to as the Internet 104, primarily comprising an interconnected network of routers and switches responsible for transmitting data packets from one location to another.

The problem with this traditional client-server architecture is that it does not take advantage of opportunities presented by excess processing and storage resources located where desktops or local networks and the Internet intersect. During the last several years, computer system hardware capacity has increased at a greater rate than have the requirements of local applications that employ that hardware capacity. FIG. 2 graphically illustrates this phenomenon using desktop computer systems as an example. With particular reference to FIG. 2, increases in processing power 200 are mapped against time 202. While not drawn to scale, FIG. 2 conceptually illustrates that while both desktop capacity 204 and desktop application functionality needs 206 have increased over time, the desktop capacity 204 has increased at a greater rate. This phenomenon results in unused local computing capacity 208.

In order to attempt to capitalize on the opportunities presented by the unused capacity 208, prior systems have tried to come up with a method for distributing certain functions of a Web page to a local system. These efforts have been largely unsuccessful. Some have tried to solve the problem by increasing the number of servers for transmitting content to end users. This is done in order to place servers in closer geographic proximity to the requesting users so that data packets do not have to be transmitted over such great distances. However, these geographic servers are still hindered by problems such as latency and congestion, which are inherent in any transmission over a network. The client system requesting the information is still limited by the processing capacity of the server and the bandwidth limitations of the Internet.

While it is possible to save a source file comprising a Web page to a local computer, that ability alone is of little use. There is little to no standardization or organization in the way files are saved onto the local system. If referenced content is stored locally, it is stored in a location relative to the source file. The location in which the content is stored may not be intuitive to the user downloading the Web page, and assigning a relative location does not allow the user to control organization of content on the local system. For example, choosing to download a Web page from a standard network connection can transfer one or more folders to be saved on the local system. The folder can contain an HTML document comprising the Web page. The HTML source will then refer to content in that same folder (or predefined, included sub-folders). Because these references are relative, the user cannot customize the installation and change the location of the content without rendering the relative content references inoperable. Additionally, certain types of content may require a Web browser plug-in application to operate, or they may not be able to be downloaded at all.

Use of cache memory is also a well-known way to decrease the number of times data is requested from a server. Once data is requested from a server, it is stored in temporary cache memory for a certain amount of time. Subsequent requests for that same data can then be retrieved from the cache memory as opposed to the server. Often the cached data is stored on a proxy server that may serve more than one desktop computer. While using a proxy server and cache memory are well known, they provide only temporary storage and require frequent updating. Also, proxy servers still employ sub-optimal client-server architecture. There is still a server controlling the entire process and limiting the transmission of data. Large data objects will still experience sub-optimal delay when being transmitted over a network.

One overarching problem that has plagued attempts to adopt a distributed network model has been that there is an extremely wide variety of possible platforms and configurations of systems onto which content can be distributed. The result is an managerial nightmare for those administering the distribution of content. Content must either be kept simple, so that it can be easily adapted to diverse target platforms, or it must be extremely rigid in structure, allowing easier administration but preventing end users from customizing the content to meet their particular needs. What is needed is an ability to standardize development of a portable Web site that can be installed on multiple, diverse platforms and customized at install-time or upon updating to optimize use of the particular configuration of the system on which it is installed. This solution can be best obtained with a fundamental redefinition of the client-server architecture paradigm. The present invention presents such a solution.

### SUMMARY OF THE INVENTION

Web sites can be robust, diverse, and very complex. In order to deploy and display them in the most effective manner, the present invention redefines the client-server architectural paradigm. While transmission of data over the Internet has traditionally involved a remote client system sending a request for information through the Internet to a server that sends the requested information back through the Internet to the client system, the present invention takes advantage of the mezzanine of the Internet. As used throughout this application and the attached claims, the terms “mezzanine” or “mezzanine of the Internet” are coined phrases and are meant to refer to any of several possible computer systems located along a networking communication route between a typical remote server initially storing content, and an end user requesting the content.

By creating a uniform protocol for making Web sites portable, the present invention enables and effectively creates an entirely new processing context in what can be referred to by coining the term “mezzanine of the Internet. “Prior to the present invention, content servers could be deployed at intermediate locations on the Internet for the purpose of storing and forwarding data objects only. Applications involving procedural logic could only be executed on remote servers or end-user processing platforms. The problem of integrating data object store-and-forward operations with the remote application server paradigm is non-trivial and only addresses bandwidth (latency) problems.

The present invention allows for the relocation and optimization of processor capacity resources, bandwidth optimization, and optimization of the procedural component of the application based on a wide variety of destination contexts. By enabling the structured distribution of a very robust class of applications (i.e.,Web sites), portable Web site technology creates an entirely new processing venue (the mezzanine), thereby enabling the development of entirely new network applications that rely upon the technology's ability to transform an application into a wide variety of forms. The technology leverages and creates synergy between this new class of applications and very powerful and easy-to-deploy hardware platforms on which they run. Together, these technologies enable the Internet to deliver information and entertainment faster and at a lower cost than ever before.

Some examples of computer systems populating the mezzanine of the Internet include servers geographically proximate to the user; local intranet, LAN, WAN, or wireless servers; and even the user's desktop computer system. Consistent with the present invention, Web sites can be stored locally on any mezzanine system in order to optimize data deployment to the end users.

To take advantage of the unused capacity of mezzanine systems, the present invention incorporates a systematic, organized, and highly structured, yet customizable, procedure for optimizing deployment of data from a remote primary server to any platform or location from which the data would be most optimally accessed. This is accomplished by globally replacing Web site source references with tokens. The tokens are then instantiated on install time and resolved specific to the target platform.

Consistent with a preferred embodiment of the present invention, a relocatable Web site (or “portable Web site”) can be developed and deployed in the following manner. First, a portable Web site can be created from a pre-existing site or developed from scratch. With pre-existing sites, the clearer and more technically precise the code used by the programmer to develop the site, the more successful the development of the portable Web site will be. All necessary source code and referenced content are assembled. The source code can be in any text-based language (such as HTML, XML, DHTML, Java, Javascript, Perl, C/C++, and the like). In addition to providing Web site content, other items necessary in order to use the content can also be provided to the user. These items can include things such as Internet browser plug-in applications. A data file is then provided for token resolution, and a script is called to compile the source code and replace any desired references with the necessary token.

All of the content, including the tokenized source code is then transported to the user for installation on the desired destination system. The content can be sent via an Internet download, or on portable storage media. Upon installation on the destination system, the tokenized references are resolved to maximize/optimize performance based on the current configuration of the destination system. The user installing the portable Web site can also override the default instantiation of the tokens and resolve them in a customized manner. After installation, updated content can be periodically provided to the user. Updates can be automatically based on a time-stamp, or upon specific request by the user. Original installations and updates to content maintain local preferences or optimizations, and the installation can be changed if desired, or if the local system configuration changes.

A preferred system consistent with the present invention includes three sub-systems: a development system, a compiler system, and a deployment and delivery system. The development system provides an easy-to-use graphical, hierarchical file management system. It allows for program check-out during use and it affords version control. The compiler system includes the script used to globally replace references with tokens.

The deployment or delivery system preferrably includes a content compression module, a server-side content transfer module, a client-side content transfer module, and a content installation system. Together these modules compress the transported data, provide desired encryption and security, and then decompress the data at install-time and install the data in a manner dependent upon the configuration of the destination system. The installation can occur through detection and recognition of local resources, or through enabling a user to select from or define local conditions or local parameters of the destination server.

One aspect of a preferred embodiment can also include a local Web portal interface. The local portal provides the user with a simple interface for accessing both the Internet and the portable Web sites that have been installed on the local destination system. By using the local Web portal, the user is seamlessly and efficiently able to access content stored on the mezzanine of the Internet, as well as across the Internet, employing a traditional Internet navigation graphical user interface.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 shows a client-server architecture paradigm typical of the prior art.

FIG. 2 shows the change in desktop system and application processing capacity over time, resulting in unused capacity.

FIG. 3 illustrates a client-server architecture paradigm consistent with the present invention. FIG. 3 particularly points out the Mezzanine of the Internet and various locations at which a portable Web site can be installed.

FIG. 4 represents computer modules and programs comprising a system consistent with the present invention.

FIG. 5 illustrates a GUI of a development module embodied in a dynamic content editor.

FIG. 6 is a flowchart illustrative the process of relocating a Web site.

FIG. 7 schematically illustrates the conversion of diverse file types into a portable Web site using a super-language compiler.

FIGS. 8A-8C illustrate an HTML source in which original references are replaced with tokens that those tokens are subsequently resolved to a destination system configuration.

FIG. 9A-9C illustrate a GUI for a local portal for portable Web sites.

### DETAILED DESCRIPTION OF A PREFERRED EMBODIMENT

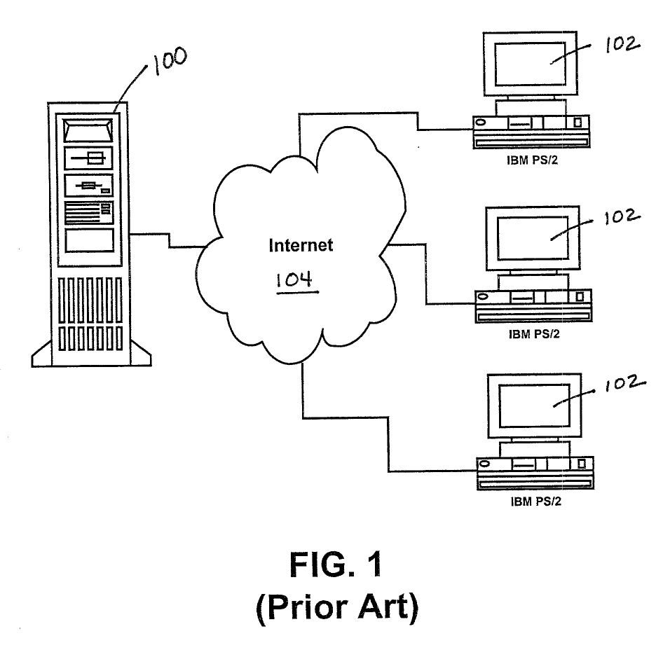

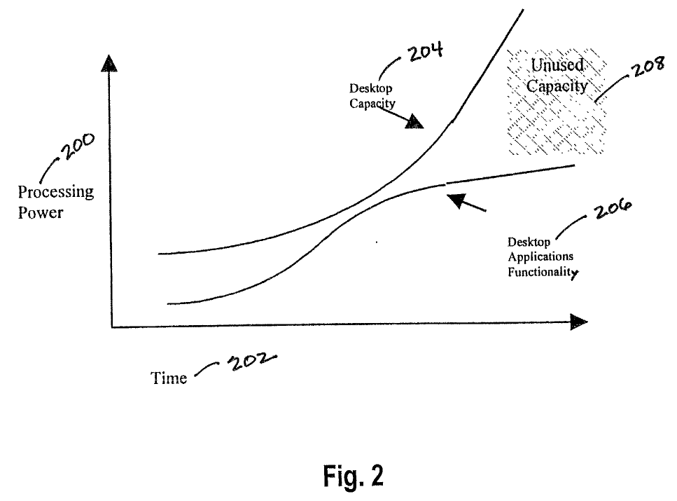

As illustrated in FIG. 1, a traditional client-server architecture assumes the presence of a remote server 100 sending information over a network 104 to a remote client system 102. This paradigm, however, is inefficient and fails to capitalize upon unused resources in the mezzanine of the Internet (the various computer systems between the end user and the server). A preferred embodiment of the present invention comprises a system and method for taking a Web site available on a primary server, and creating a portable version of the Web site for installation on a destination system within the mezzanine of the Internet. This technology enables different variations of that master site to be deployed even in locations not typically used to host or serve Web pages.

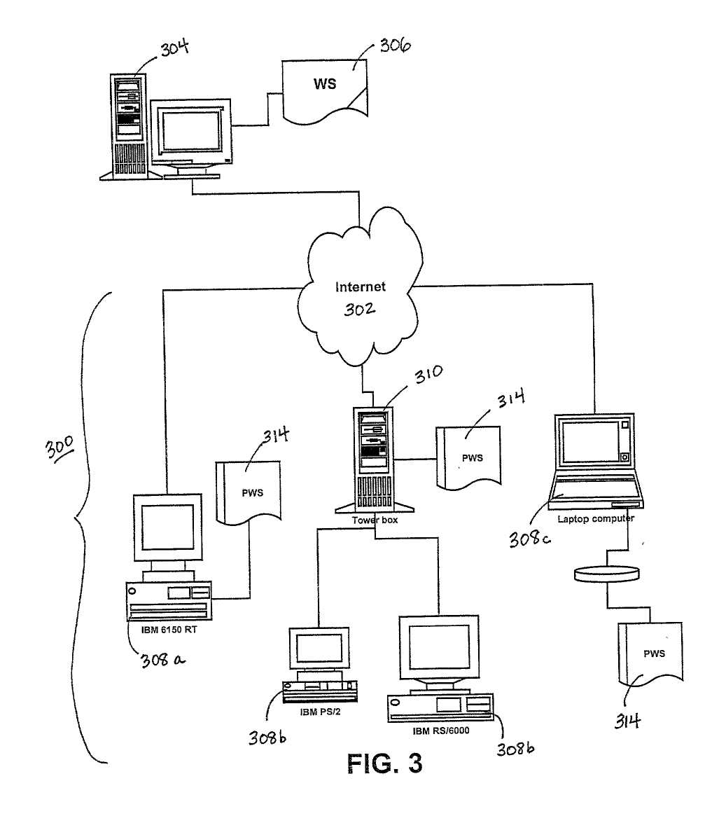

With the Internet, there is an extremely large global audience for available content. The challenge is to optimize access to the information. One way to do that is to move the content closer to the end users. Doing so reduces time delays associated with sending data over a network connection. FIG. 3 conceptually illustrates the concept of the mezzanine 300 of the Internet 302. The mezzanine 300 can comprise several desktop computer systems 308a-c as well as local servers 310, such as those used in local internets, intranets, LANs, WANs, wireless networks or the like. Each system in the mezzanine 300 is connected to the Internet 302. At some remote location, a primary content server 304 is also connected to the Internet 302 and hosts a master Web site 306.

Rather than having the computer systems in the mezzanine contact the primary content server 304 to access the Web site 306, the present invention makes the Web site 306 portable and installs it as a portable Web site 314 within the mezzanine 300. The portable Web site 314 is installed for optimal performance on any given system. The portable Web site 314 can be installed on the hard drive of a desktop computer 308a, on a local server 310 accessed by other desktop computers 308b, or even stored on a portable storage medium 312 for operation in a computer system 308c. Examples of portable storage media include CD-ROM, DVD, computer disk, or other forms of electronic, magnetic, or optical storage devices. Similarly other configurations are also possible for computer systems within the mezzanine 300. Such configurations can include such things as wireless networks and will be well known to those skilled in the art. By placing Web sites and referenced content where the connections to the Internet 302 are made, users requesting content can be serviced without having to transmit or receive data across the Internet 302, thus reducing transport time that would otherwise be lost to latency, congestion, or similar network-limiting factors.

Portable Web sites can comprise a single compressed data file consisting of HTML, XML, DHTML, or other markup languauges; source code from a variety of programming languagues; and binary data. In order to make sure that a portable Web site can be relocated from the primary content server and installed in a vast array of potential destination platforms or computer systems, there needs to be a uniform, reliable way of resolving certain types of references on a Web page so that they can be made portable. Reliability can be achieved by adopting a standard for reference tokenization and token resolution at install time. By allowing the tokens to be resolved at install time based on system configuration, the system can achieve increased flexibility and adaptation to a wide variety of destination system configurations. The preferred method to ensure that the token resolution is valid on installation is by having a structured set of software tools specifically designed to standardize the process of making a Web site portable.

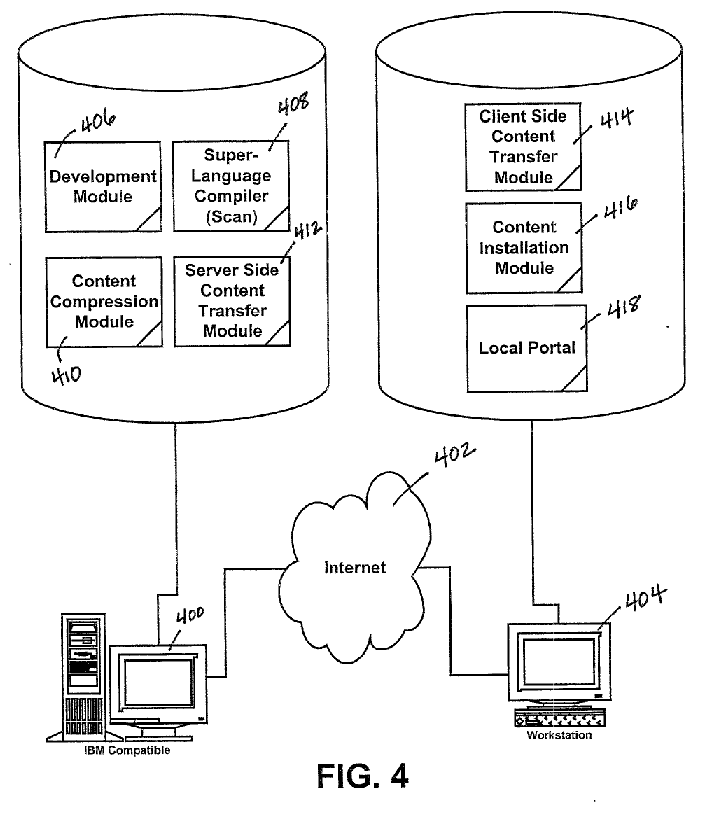

An example of the preferred system for enabling portable Web sites can comprise multiple interrelated modules or computer programs. One such system is conceptually depicted in FIG. 4. With reference to FIG. 4, it can be seen that some modules or programs can operate on the primary content server 400 side of the Internet 402, and some can operate on the destination system 404 side of the Internet 402. Examples of those preferably implemented as part of the primary content server 400 include a development module 406, a super-language compiler 408, a content compression module 410, and a server-side content transfer module 412. Examples of modules or programs preferably implemented as part of the destination system 404 include a client-side content transfer module 414, a content installation module 416, and a local portal 418. Each of these modules or programs will be further described below.

One example of a module operating on the server 400 includes a development module 406 used to provide a simple graphical user interface for assembling content for inclusion in the Web site. One characteristic of a portable Web site is that the entire site, referenced content such a multi-media clips, graphics, or related files, are packaged together in a relocatable form. The development module 406 can provide a easy method for gathering and organizing portable content. In addition to being able to gather files, the development module 406 can also allow a site developer to edit files.

The development module 406 can also provide document management capabilities such as file check-out during editing and version control. The development module 406 can also allow group contributions to the development of a portable document, such as by allowing multiple-user contributions over a distributed system.

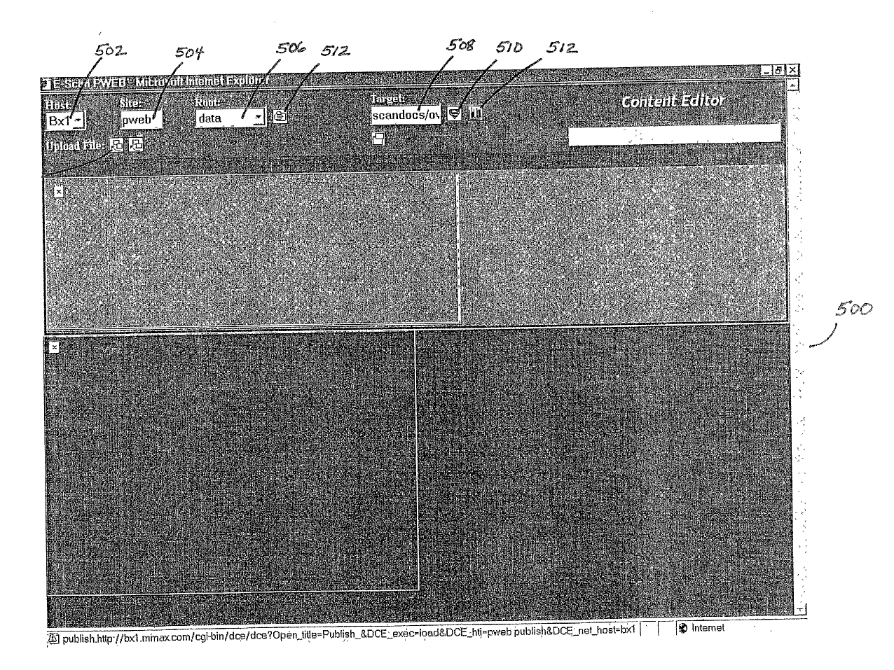

FIG. 5 shows a development module as embodied in a document content editor (DCE) 500. The DCE 500 can be a simple browser interface to the super-language compiler. It enables a user to graphically browse and edit files. It can also have interactive controls to specify file or system information such as the host 502, site 504, the root 506 (characterizing the file), and the target 508. In a preferred embodiment, the DCE 500 can also include an interactive button 510 (enabled by Javascript or a similar computer language) to run the multi-language compiler. Other interactive buttons 512 can also be included to provide other optional functionality, such as copying, deleting, renaming, uploading, or transferring files.

The DCE can function as a front-end to the super-language compiler, and serve to solve two key problems: 1) provide access to the source-tree for a portable Web site via the browser; and 2) provide a graphical view of the source-tree and tools for easily finding logic and data structures within the entire complex of the Web site. The DCE is itself a portable Web site and takes advantage of the super-language compiler to tailor front-ends for specific purposes and for specific users of a Web site. The target audience for the DCE may include sophisticated Web developers familiar with a wide variety of abstract editing concepts, or end-users who want to make routine and simple changes to the content of a site.

The DCE can support several key aspects of the development process. The first aspect is source library control. Users can check out, modify, and then restore any element of the portable Web site using either the custom source editor, or any content editor they choose. The second aspect is access to server processes. Primarily, this means the ability to re-scan a source file after making changes to it. However, the DCE is designed to provide access to a variety of other server-based resources and package them for end-users of all skill levels. The third aspect is content updating. During the development process, content changes are typically made on a development instance of the Web site. Once those changes have been tested, they are re-integrated into the portable Web site data structure by a process referred to as “porting”. The fourth aspect is publishing. Once data has been ported, it can then be published to any client platform. Publishing is actually a client-pull process wherein the client requests all of the content of the portable Web site that has changed since a previous installation date/time.

Again with reference to FIG. 4, the super-language compiler 408 is a pre-processor that uses global data definitions and shared macros and logic modules to leverage the development process. Because the super-language compiler 408 rapidly reads markup language documents, source code, and binary data, the super-language compiler is hereinafter referred to as “Scan.” The following subsections describe the functionality and operation of a presently preferred embodiment of Scan.

### Overview of Scan

Scan is a language pre-processor which allows Web developers to construct and maintain complex Web sites using global data definitions and shared macros and logic modules, which leverage the development process. In the preferred embodiment, Scan is a CGI script written in the Perl programming language. However, the source code to conduct the procedures of Scan could be written in other programming languages as well. Utilizing Scan as the foundation tool for Web site development reduces development time and enables developers to package and deploy Web sites in a variety of contexts, including private intranets, geographically optimized Web servers, server farms, and direct installation of content on the end-user's desktop.

Relocatable Web sites are called “portable” because they can be packaged, transmitted and then installed independently of the primary Web server. Once installed, remote copies of a Web sites can be updated and synchronized with the master site with little or no user intervention. Portable Web sites represent a formalized approach to utilizing client-server architecture in distributed Web site design.

During compilation, Scan is able to resolve global data references and integrate generalized logical constructs and propagate them to different versions of the Web site. Compilation allows leveraging a body of source code in any variety of contexts. A simple example would be generating browser-specific versions of a Web site, or perhaps audience-specific versions (foreign language support for example). Compilation also allows us to take certain key references within the site and generalize them so that we can resolve them later. This enables the installation phase described in more detail below.

Scan takes any source file and manipulates it, resolving and then removing its own logic and data structures, and leaving a pure source file that conforms to any target compiler or script language execution environment. Typically, the languages involved are: HTML, Javascript and Perl. However, with some minor syntax issues excepted, Scan can support any text source format and allow the developer to access a common set of data definitions and logic structures that are independent of the individual languages involved.

Scan is important to the development process for a variety of reasons. First, by supporting a system of global data references, key elements of the Web site can be referred to logically and therefore changed globally in a single step. Second, by integrating external data sources, developers can separate relatively static formatting and design constructs from data sources that may change very frequently. Also, by separating data content from design content, clients are able to interact with and update data content much more easily. Third, by enforcing a uniform system for referring to the server platform on which the Web site will run, the developer can create a generic Web application, and then deploy it in a wide variety of contexts and on a wide variety of platforms.

Fourth, by providing logic control and the ability to design elements of the Web site in a procedural form, repetitive tasks are reduced in favor of logic structures that are executed at compile time, thereby leveraging the design of the site. Fifth, because Scan integrates with a variety of script languages, it provides a means for individuals unfamiliar with specific programming languages, like Javascript and Perl, to cooperatively develop content with programmers who are familiar with those more challenging environments. Scan actually allows re-packaging of some of the powerful features of Javascript and Perl (to cite the most common examples) so that novice users can utilize them in the context of an HTML development environment.

### Scan Command Line Arguments

The following provides a reference guide to command line options that enable users to direct the performance and behavior of Scan at run-time.

Cmdline: scan—Version 1.01; syntax: scan [{options}] {files}; summary: Scan is a source code pre-processing system. Scan allows a group of people to construct and maintain complex browser-based applications in a coordinated fashion and to utilize common program logic modules and data definitions that may apply to one or more Web sites.

Scan is not language specific, so any text-based source language can be utilized with Scan. Scan can coordinate server configuration files, construct database queries, create C language macros that generate database aware source code, as well as all the more commonly recognized coding environments associated with Web sites.

Scan allows one to generate compressed and relocatable Web sites that can be deployed on a wide variety of servers and configured dynamically at install time using install-time data definitions. By exporting and then publishing an updated Web site, a developer can control the development process better and propagate changes to target audiences with a level of control unavailable under any other system.

Cmdline: version—select an output version; syntax:—version:{vid}[,{vid}]; summary: Select versions to generate. Scan can generate multiple versions during its second pass at the sources. By requesting multiple versions, you can save the time on the first pass if more than one version is needed.

Cmdline: class—set Scan source class; syntax:—class:{class}; summary: Set the default class prefix. Normally, Scan looks for system files with a class prefix of ‘scan’; however, setting the class to another value allows you to maintain discreet source sets with different default values if necessary.

Cmdline: makemap—update map file; syntax:—makemap:{vid}; summary: Store source map information when generating this version. In most cases, you will want to generate source mapping information for all versions. The source mapping files allow the dynamic content editor to create the source tree on your content editor, and the map files are also used to optimize re-scanning large Web sites.

Cmdline: mapedit—enable dynamic content editor; syntax:—mapedit:{Y}; summary: Include Dynamic Content Editor in version. The DCE is a context-sensitive editing system. It embeds additional javascript in each output page so you can double click on the page and go right into the content editor. The source tree you see using the DCE context is limited to the files that directly affect the page you are looking at, so you do not have to sift through irrelevant source code while editing a particular page.

Cmdline: skipto—skip to output page; syntax:—skipto:{output spec}; summary: Skip to a specific output page. Sometimes a Scan source file will generate large numbers of output pages by reading a database or flat file. Skipto tells Scan to ignore intermediate output cycles until it finds the particular page you are looking for. This allows you to utilize powerful program logic to generate large numbers of pages, but still provides a means of scanning and previewing an individual page as part of that larger set.

Cmdline: loadsubs; syntax:—loadsubs:{subfile}[{subfile}]; summary: Load additional sub files. Scan uses a sophisticated protocol for finding global data definition files (.sub) whenever you build a Web site. Normally, the file structure itself provides a logical way to define data. This command line option allows you to direct Scan to load data definitions from any arbitrary location in addition to the places it normally looks for sub files.

Cmdline: portver—output portable version; syntax: -portver:{vid}; summary: Generate portable content. This command instructs Scan to generate a portable version {vid} of the current Web site. Typically, {vid} will be either ‘htp’ or ‘cgi’, depending on whether or not you are producing content intended to run under the user's browser (htp), or content which will be generated dynamically by the server (cgi).

Cmdline: addlib—add library path; syntax:—addlib:{directory path}; summary: Add a library to the current library list. Scan creates a list of directories in which it looks for source files, macros, include files, sub files, etc. Normally, the file system itself is set up such that there is an appropriate default location available to store these files. However, for special purposes, such as the maintenance of snap-in applications, you may wish to dynamically add an additional library.

The addlib command adds the referenced library to the end of the library list, so that it would be consulted first for data definitions, and last for source files. When adding libraries, it is important to keep track of where they fit in the hierarchy because data definitions are frequently pre-empted or overwritten by files which have higher precedence.

Cmdline: putlib—put library path; syntax:—putlib:{directory path}; summary: Add a library to the current library list. This works exactly like addlib, except that it puts the library at the front of the list instead of adding it onto the end.

Cmdline: here; syntax:—here; summary: Output file to current directory. Sometimes for debugging purposes, you may want to force Scan to generate its output file in the current directory, regardless of where the file would normally be output. This is a convenience feature that allows you to get at a copy of the output file without having to navigate the file system. You can also use this feature to make test changes to a file without altering the primary or live copy.

Cmdline: memvar; syntax:—memvar:{name}={value}; summary: Create a memory variable visible to Scan. In a preferred embodiment, Scan is a perl program, and as such, you have access to the memory space supported by perl as it scans your source code. Normally, when you create a Scan variable, it is stored in a specific internal table, which is discreet from the perl memory space. However, there may be times when you need to create, reference, or assign an arbitrary perl variable name that circumvents Scan's normal variable naming system.

Cmdline: asof—output as of a date/time; syntax:—asof:mm/dd/yy@hh:mm:ss; summary: Only generate new content for changed pages. Scan keeps track of the date/time stamp on all included or referenced files used to generate a given page. It calculates what we call a ‘high-water mark’ on each page and stores that date/time in the source map so we know which pages may have changed due to a file modification. The ‘asof’ command line option tells Scan to disable content generation for pages older than the specified date/time. On large Web sites, this can substantially reduce the amount of time it takes to update the entire site when you are not sure which pages have changed.

Cmdline: var—set variable content; syntax:—var: {name}={value}; summary: Set or create a Scan variable. This command line option creates a variable that is visible to all the source scripts processed during that session. Typically, this would be used to activate or de-activate some special page logic for a temporary purpose. This provides a means for you to pass parameters to macros and templates without having to change the actual sources.

Cmdline: subfile—load subfile; syntax:—subfile:{filename}; summary: Load a data definition subfile (.sub). Scan uses global data definition files to coordinate your Web site content. You can specify the name of a subfile on the command line, and Scan will attempt to locate the nearest file matching that name.

Cmdline: srcfile—load source file; syntax:—srcfile:{filename}; summary: Load a remote source file. Scan allows you to reference source files in other directories that are part of your Scan source tree. If the file you request is not in your current directory, Scan will track it down higher up the chain in any available library directory. This allows you to share access to common HTML pages, or provide default backup content pages available on-demand from a common location.

Cmdline: newport—reset portable content; syntax:—newport:{version}; summary: Reset your portable content file. As you work on your Web site, portable content updates may accumulate and sometimes you may want to start over with a clean slate. This command tells Scan to clear the portable content file associated with the named version before generating any new content.

Cmdline: okmkdir—ok to create new directories; syntax:—okmkdir; summary: Tell Scan to create new directories if necessary. When creating output content, Scan normally issues an error message when the target directory does not exist. The ‘okmkdir’ option overrides this and tells Scan to automatically create any new directories you may need.

Cmdline: undefs—show undefined variables; syntax:—undefs; summary: Display undefined or unused Scan variables. As Scan reads your site content, it attempts to resolve any of the special variable name references you may include in your source code. If a variable name is unreferenced in the site and no definition has been provided, Scan will issue an error message at the end listing any and all such variable names. The purpose of this is to let you know when a variable name you may think is being resolved is not being resolved, or perhaps a typo has created an incorrect reference.

Cmdline: testrun—display library paths; syntax:—testrun:{seconds}; summary: Display library paths and source file names. This diagnostic option displays the list of libraries used to compose an output page. If a number of seconds is provided, Scan will pause that number of seconds before proceeding.

### Scan Directives

The following provide a reference guide to Scan compiler directives and an explanation of the first pass source assembly process.

Scancmd: scan directives—pre-processor directives; syntax: #—scan:{directive}; summary: Specify a pre-processor directive. Directives are processed during the first pass while Scan is assembling the sources for output. It is important to understand that directives have their effect before any template or logic processing takes place, and they influence the construction of the temporary source file Scan uses to create the final output document.

All directives are specified using the standard Scan comment structure: #—scan: at the start of the source line. The # character is often viewed as a comment character by programming languages, so its possible to have Scan directives in a source file without compromising the original source language. However, because Scan is a pre-processor, it will normally strip out all comments anyway before passing the final output document to the target programming language.

Scancmd: template—define template; syntax: #—scan:template:[end]; summary: Define the start or end of a Scan template. Scan processes source files in two passes. In the first pass, it assembles all the required source files, macros, and includes files into a common temporary file. During the second pass, it resolves global data references and interprets any templates found in any of the included files.

A template defines a special section of the source that can utilize Scan commands and logic control over the content, which is actually output to the destination file. Usually this is an .htm file, and the output is HTML. However, Scan allows you to construct output from any source language, and you can utilize its logic control and macro capabilities to leverage the original content in a wide variety of ways. You must provide an ending or closing template statement to match up with each opening template statement. For example: #—scan:template:end;.

Scancmd: outfile—specify output file; syntax: #—scan:outfile:[{path/}][{filename}]; summary: Define the data path and/or filename for output. Scan attempts to determine the output filename from any source based on its original name and file type. However, you can override the default path and name by specifying either component with the ‘outfile’ command. If you specify the path only {path/}, it must end with a slash character so Scan knows that you intend to define the path but not the filename. If you specify the filename only, Scan will use the default path with the filename you provide.

Scancmd: setmode—set output file mode; syntax: #—scan:setmode:0nnn; summary: Set the file permissions of the output file. If you are generating a Perl or Unix shell script, you may want Scan to set the executable mode of the output file so that it will execute properly under the Unix operating system. This command instructs Scan to set a file mode when it outputs the file. If the content you are generating is portable, Scan will store the requested mode setting with the compressed version of the file, and the portable content installation program will set the mode at install time.

Scancmd: setvar—set Scan variable; syntax: #—scan:setvar:{varname}={varvalue}; summary: Instantiate a Scan variable. It is often useful to establish a Scan variable that is part of the source file itself. In this way, the source file guarantees the value of that particular variable after all dependent .sub files have been read.

Scancmd: subfile—read .sub file; syntax: #—scan:subfile:{filespec}; summary: Instruct Scan to read a sub file. Because this is a directive, it is a way to force Scan to utilize a sub file while it is assembling the source file, and not rely upon supporting libraries for that purpose. Keep in mind that the contents of a sub file included during the first pass affects each subsequent line read during the first pass, and may affect templates or macros executed during the second pass.

Scancmd: copyto—copy raw text content; syntax: #—scan:copyto:{path}/{filename}; summary: Copy the Scan source file in raw form. If the source file you are creating is intended to be used as a library or included file by another Scan source file, the ‘copyto’ command allows you to transfer the contents of the file without translating global data references or executing templates. This is essentially the equivalent of copying the file to another location, except that it is handled by Scan as if the file were an actual Scan source. This command must be placed on the very first line of the file in order to copy the file intact.

Scancmd: include—include another file; syntax: #—scan:include:{filespec}; summary: Include an external file in the current source. This simply includes the contents of another file as if it were part of the current source file. This command should not be used inside a template. Note also, Scan will not include the same file twice in the same source. If you want to insert the same file multiple times, use the ‘insert’ command instead.

Scancmd: insert—insert another file; syntax: #—scan:insert:{filespec}; summary: Insert a file. The ‘insert’ command includes a file regardless of how many times it has been included before. Generally, included content should only be used once. If you need to include the same content multiple times, a macro file can usually do the job more efficiently.

Scancmd: require—include file at end; syntax: #—scan:require:{fflespec}; summary: Include a file after the primary source file. “Require” tells Scan that the named file must be included with the primary source, but that it should be included only after the primary source file has been loaded. Scan makes a list of all ‘require’ files and then serially appends them to the primary source after it has read the entire primary source (and all its includes). The typical use of the ‘require’ command is to specify the names of library files that contain macros, content, or other templates that may be needed by the primary source, but should not be processed in line with the primary source.

Scancmd: waitfor—wait for content syntax: #—scan:waitfor:{filespec}; summary: Wait for a section of an external file. This allows you to scan an external file and only include a section of the file. The file must include a comment line which Scan recognizes and which matches the string requested with this command. “Waitfor” amounts to selectively including a part of another file. It can be used to extract HTML from another development environment, typically Front Page or Dreamweaver, for example, where the content is being maintained under a WYSIWYG editing tool, and you need to extract only a portion of that content for inclusion in your portable Web site.

Scancmd: loadsubs—load subfiles like; syntax: #—scan:loadsubs:{spec}; summary: Load a class of subfiles. Part of the power of using Scan is its ability to select content from a multi-level file system. By specifying a special filename, Scan will search all of the libraries it knows about for files matching the {spec} and load the data definitions contained therein. This allows a developer to establish a class of data definition that is used by certain Web sites or Web pages for a specific purpose. For example: you could put the scan directive: #—scan:loadsubs:paim.sub; in a source and gather data definitions specific to a version of the Web site intended to support Internet access via the Palm pilot.

Scancmd: addlib—add library; syntax: #—scan:addlib:{path}; summary: Add a library to the current library list. This adds a library onto the end of the current list of libraries that Scan knows about. Libraries may contain macro files, include files, or any of the various types of content which Scan coordinates to produce an output file. By adding libraries during the first pass through a source file, you can expand the scope of the library list in support of whatever content there is in the file itself.

Scancmd: putlib—put library; syntax: #—scan:putlib:{path}; summary: Put a library in the front of the current list. Because Scan searches for files sequentially through the list of libraries it knows about, putting a library at the front of the list affects its precedence in a search. When scan is searching for a specific file, it starts searching at the library or directory location closest to the end of the library list. When reading a series of data definition files, it starts at the beginning of the list (the files farthest removed from the source file), and reads each subsequent file found. This way the closer a sub file is to the source file being processed, the higher its precedence. This an important part of Scan application design. Organizing data definition files so they can be pre-empted by other files allows a group of users to share content and yet refine and customize elements of the source tree for specific purposes without invalidating other elements of the source tree.

Scancmd: setvers—define version properties; syntax: #—scan:setvers:{versid}:{properties}:{outfile}; summary: Define a specific output version. Scan allows you to maintain sources that can produce a wide variety of different output versions. A typical example would be a Web site designed to support multiple browser environments. By writing Scan macros and templates with awareness of the properties of a version, you can construct output sets that are tailored to a specific end user environment. As more and more types of devices interact with your Web site, the ability to organize and code different variations of the site easily will become an essential need.

Scancmd: version—generate named version; syntax: #—scan:version:{versid},{versid} . . . ; summary: Instruct Scan to output a named version. This instructs Scan to output the named version after completing the first pass through the source file. Normally, Scan outputs a version called ‘def’. However, you can request Scan to output any named version, as long as Scan knows what the characteristics of that version are. Typically, versions are used to setup multiple output versions of some files that target different operating systems or browsers. The ‘version’ command also allows you to access version specific .sub files. Whenever Scan outputs a version, it pauses at the beginning of the second pass and attempts to read any sub file with the prefix: ‘vers.’ that matches the named version it is outputting. So, if you selected a version of ‘win95’, Scan would look for any file called ‘vers.win95.sub’ in any of the libraries known to it at the start of the second pass. This allows you to change the values of key Scan variables in a way that is specific to a particular version without affecting other versions.

Scan uses this version control system to output portable content. By setting key system global data definitions in the version file for a particular output set, you can instruct Scan to make that output portable simply by setting the appropriate global data values at that time. This is a key capability that allows Scan to tokenize absolute references in a source file such that they can be resolved later at install time.

### Scan Language Commands

The following lists Scan language commands and logic control structures used in the creation of templates and macros.

Langcmd: scan language—template control language; syntax: #—scan:template:; summary: Define Scan templates. Templates are simply sections of source code that are output under the control of the Scan programming language. A typical Scan template consists mostly of native source code with a few strategically placed Scan logic control statements, file i/o statements, or variable assignments. A simple example would be a Web page that is intended to include a disclaimer at the top when it is in draft mode and discard the disclaimer when in final mode: ”:unless:final_draft==Y This is a Draft Document Only. :endif”.

The Scan language command ‘unless’ is used in conjunction with a Scan variable name ‘final_draft’ to decide whether or not to include the text ‘This is a Draft Document Only.’ in the output file. This technique is representative of the uses of Scan to manage the development process for a Web page, or a wide variety of other language and/or text content related applications.

Scan can be used not only to product Web pages, but also for a wide variety of other purposes. It can be used to construct queries for SQL servers, we use it to build configuration files on intranet servers and manage the installation of a variety of important Internet related server applications that need to be tailored to a given internet environment.

Langcmd: macro—macro template; syntax: #—scan:template:macro: {name}: [{args}, {args} . . . ]; summary: Define macro template. A macro template is simply a template that is not processed unless it is called by another template. As in most programming languages, the ability to encapsulate certain functions within a named context helps create easier to read and easier to use code. The Scan macro provides a simple sub-function capability and the ability to instantiate parameters when the macro is called that represent current data values.

A Scan macro operates in and addresses the same memory space as its caller, so a macro that creates variables leaves them active even after it is called. Parameters passed to a macro disappear when the macro terminates, and are only created if the caller provides them. A parameter referenced in the macro definition is assumed to be blank if the caller does not provide a value.

Langcmd: mecho:; syntax: mecho:{text}; summary: Macro echo. This provides a diagnostic capability within templates and macros that allows you to see processes and status during the second phase of the Scan compilation process. Because :mecho: only occurs when templates or macros are being executed, you can follow the processing status by strategically placing these commands in your code. The {text} component of the command is any normal text line, and may contain Scan variables. This is an ideal way of tracking the status of Scan memory values while a page is being generated.

Langcmd: if,unless,else,orif,andif—logic control; syntax: if,unless,else,orif,andif:{expression}; summary: Logic control commands. Scan provides a simple boolean control capability that allows you to specify conditionals and control program execution. Each logic command must be specified on its own command line and is evaluated in sequence. Scan observes the expected meaning of the :else: command, and terminates a logic block using the :endif: command.

Langcmd: case—sequential exclusive if; syntax: case:{expression}; summary: A series of logic expressions. A :case: series evaluates until a true case is found, then ignores subsequent cases.

Langcmd: unless—the inverse of :if: syntax: unless:{expression} summary: Perl-like unless. Unless allows you to express the inverse of a logical truth statement without changing the expression operator.

Langcmd: next—continue loop; syntax: next:{expression}; summary: Continue a loop block. Next allows you to proceed to the top of the current looping code block without processing any further commands in the block.

Langcmd: last—terminate loop; syntax: last:{expression}; summary: Terminate a loop block. Last allows you to proceed to the end of the current loop block without executing any further commands, and terminate the block.

Langcmd: endif—close logic block; syntax: endif:; summary: Close a logical block. This is a required closing command that terminates the most recent open logic block created by an :if: or :unless: command. It may also reference an :else: command if one exists.

Langcmd: endcase—end :case: block; syntax: endcase:; summary: Close :case: logic block. This closes a series of sequential :case: commands.

Langcmd: while —conditional loop; syntax: while:{expression}; summary: Evaluate expression for loop block. While allows you to create a repeating loop block of commands based on the value of an expression.

Langcmd: endwhile—close :while: loop block; syntax: endwhile:; summary: Close :while: loop block.

Langcmd: readlist—read delimited list; syntax: readlist:[‘x’]{expression}; summary: Read a delimited list. By default, :readlist: processes a list of comma delimited values into a field: f_this_item. You can specify an alternate delimiter by prefixing the expression with single or double quotes containing the alternate delimiter.

Langcmd: endlist—close :readlist: loop.; syntax: endlist:; summary: Close :readlist: loop. This closes a previous :readlist: loop block. Since a :readlist: block loops, the :next: and last: commands may be used to move within that logic structure.

Langcmd: readfile—read datafile; syntax: readfile:{filename}[,{arg},{arg}]; summary: Read external data file. This command finds and then reads an external flat text file. Depending upon the type of file, :readfile: instantiates Scan memory variables that correspond to field names identified within the file itself, or that may be defined externally using the :fields: command.

Langcmd: endfile—end read datafile; syntax: endfile:; summary: Close :readfile: loop block. This closes a previous :readfile: loop block. Because a :readfile: block loops, the :next: and last: commands may be used to move within that logic structure.

### Scan Variable References

The following presents a detailed description and reference to Scan's powerful global data definition system and how it can be integrated into the various source languages used to construct Web pages.

Scanvars: scan global variables; syntax: [{varname}~~{opt}~~{opt} . . . ]; summary: Scan variable reference. Scan provides a powerful tool for incorporating variable data definitions into your source code. By enclosing a data reference in square brackets, the named reference can be identified and replaced by a memory value maintained in the Scan memory space during all phases of the compilation process. The {varname} must be alphanumeric with no embedded punctuation, all lower case. Optional modifiers {opt} are processed sequentially and delimited by the double tilde character. The modifiers provide a wide variety of transformation tools that can be used to process a memory variable at the time it is used.

Scanvars: 2uc—to upper case; syntax: 2uc; summary: Transform variable text to upper case.

Scanvars: 21c—to lower case syntax: 21c summary: Transform variable text to lower case.

Scanvars: bpg—break on paragraph; syntax: bpg; summary: Provide HTML break on paragraphs. Scan looks for double line-feed characters and substitutes a pair of HTML {BR} characters. This allows you to reference a text variable that may consist of normal text line-feeds and convert it to a format suitable for use in an HTML document.

Scanvars: nex—numeric expression; syntax: nex:{expression}; summary: Process variable as numeric value. Take the current variable and apply it as part of a numeric expression, such as +2 or /3. This enables you to take numeric values and transform them on the fly. For example, you may wish to take a standard page width expressed in pixels and derive a percentage of that width for use in a table cell width statement: [std_width~~nex:*.20]. In this example, the value of std_width is adjusted to 20% of its value and returned in the context of the variable reference.

Scanvars: ife—if empty; syntax: ife:{value}; summary: Replace if empty. The ‘ife’ modifier says: if the variable return value is blank, supply an alternative or default value.

### Scan Global References

The following exemplifies a key system global that can be used to configure the operation of Scan for specific Web development purposes.

Globals: scan global data values; syntax: $SF_{name}; summary: Scan global control data values. Scan provides a set of global values used to control the processing of source documents.

Again with reference to FIG. 4, once a portable Web site has been created and ported, the site can then be installed at the destination system. This is accomplished through a delivery system represented by the content compression module 410, the server content transfer module 412, the client transfer module 414; the content installation module 416; and the local portal 418.

The content compression module 410 helps ensure that transmitted portable data has as small of a size as possible. This can be accomplished through standard win-zip or similar compression procedures. After the content is compressed, it can be sent to the destination system. This in accomplished by the server content transfer module 412. In a preferred embodiment the destination system possesses the client content transfer module 414 to facilitate receipt of the content transferred from the server content transfer module 412. Together, the transfer modules 412 & 414 can employ security measures such as VPN or SSL transmissions, data encryption, digital signatures, or the like, to assure authenticity of the transmitted data.

The content can be transferred through various media. The preferred embodiment transfers the portable Web site object on a relatively high-capacity storage medium, such as a CD-ROM or DVD. Other means of transport, such as via Internet download are also acceptable.

Continuing with reference to FIG. 4, in the next stage, the content installation module 416, takes the new content and resolves it locally using a set of locally based data definitions appropriate to the platform on which the Web site is intended to run. The locally based data definitions are preferably determined at install time. Then can be determined by evaluating system resources or configuration of the destination system. Installation allows resolution of the tokenized references based on conditions which exist on the target platform at the time of installation. Typically these references involve the location of data sources, such as a CD-ROM, which might contain very large motion-video or audio data, or in an intranet context, a common server platform or data warehouse locally accessible over the LAN. Installation also allows for replication of the Web site on multiple servers, as in a server “farm”.

Because the tokenized references are resolved at install time, the Web site can be installed in an optimal manner by capitalizing currently available system resources. The actual installation is optimized according to the configuration of the particular destination system, so the same tokenized reference may be resolved in two completely different manners for two different destination systems. For example, if one destination system has abundant storage resources, a multi-media presentation may be stored in the persistent memory of the system. The token will then be resolved to refer to the location of the content in the local persistent memory. However, if a second destination system does not have sufficient memory, the multimedial presentation can be left on the CD-ROM used to transport the portable Web site. In that case, an identical token would be resolved differently, and the reference would be to the drive designation of the CD-ROM.

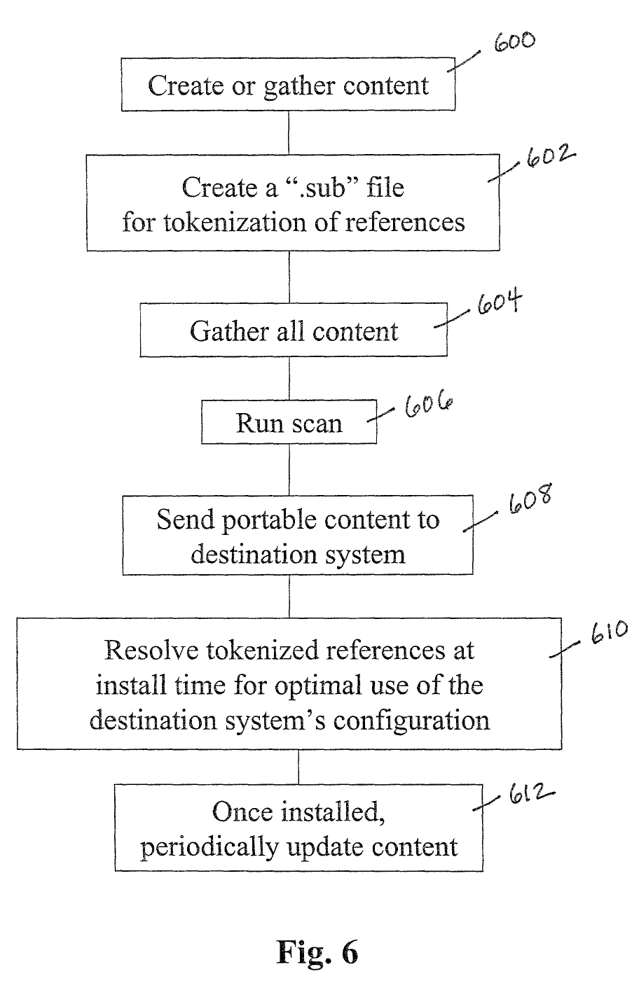

FIG. 6 schematically illustrates the process of crating and installing a portable Web site. The process begins by creating or gathering the content that comprises the Web site 600. Next, a “.sub” file is supplied to provide instructions for resolution of tokens 602. All content is then gathered 604 and Scan is run to create the portable output 606 globally replacing key references with tokens. The content upon which Scan is run can be easily identified by Scan if given a indicative filename or extension. For example, the file extension “.htx” may be used to signify that the output will be a portable HTML file. Optionally, the Scan script can be written to parse the text or source code it acts upon until it recognizes a snippet of text or code sufficient to identify the type of file or content. Scan can then parse it properly.

Continuing with FIG. 6, the portable object (preferably bundled, compressed, and in the form of a executable script) is then sent to the destination system 608. The portable object is then run on the destination system and the tokens are resolved according to the optimal configuration of the local system 610. At this point, the Web site should be a copy of the master and it should be fully operational in on the destination system. After installation, the content can be periodically updated to make sure it remains up-to-date 612.

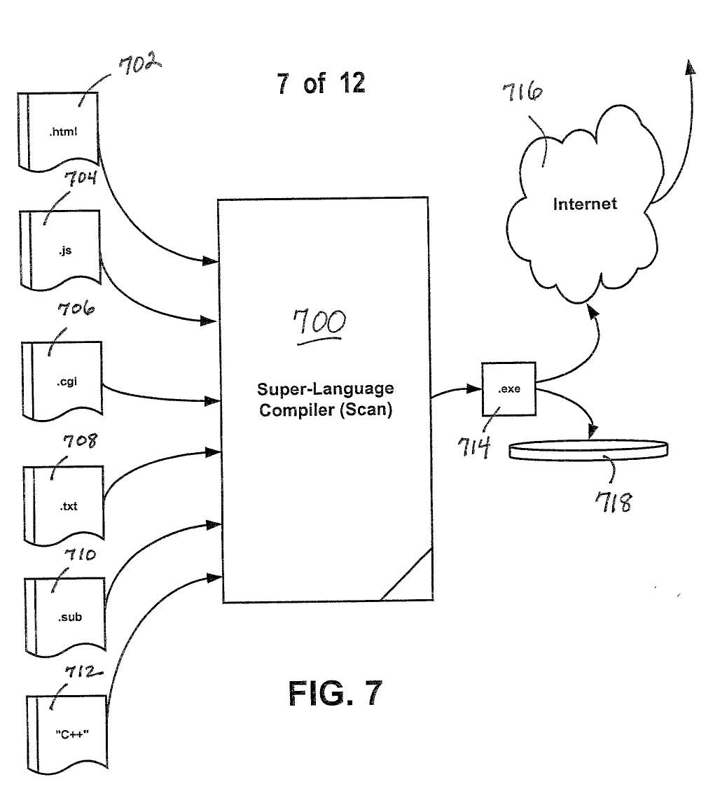

FIG. 7 also schematically illustrates the process of running the Scan super-language compiler to generate a portable Web site. As shown in FIG. 7, Scan is a super-language compiler because it can be programmed to work effectively on any text based language. For example, in FIG. 7, the Scan super-language compiler 700 can be programmed to compile sources as divergent as markup languages, including HTML files 702, and source code or data files, such as Javascripts 704, CGI scripts (such as Perl) 706, text files 708, libraries of definition files 710, or C++ programs 712. Scan 700 then generates a portable object stored as an executable script 714. The executable script 714 can then be distributed to a destination system on a portable storage media 718 (such as a CD-ROM or DVD) or via an Internet download 716.

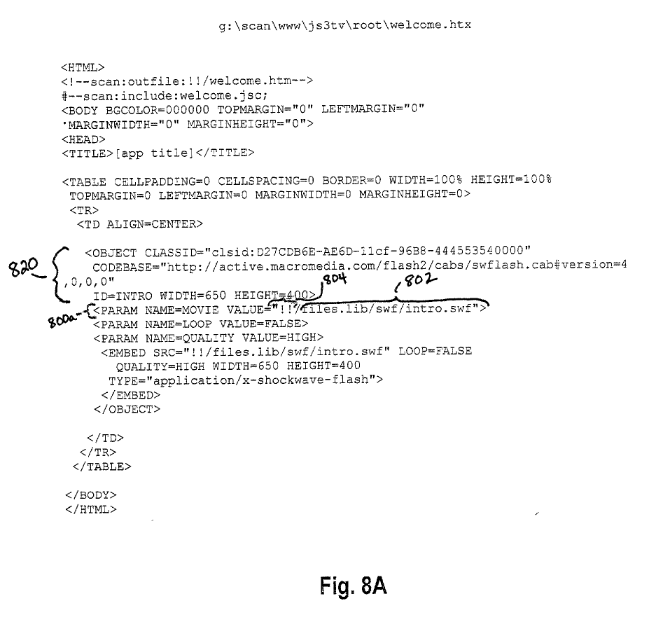

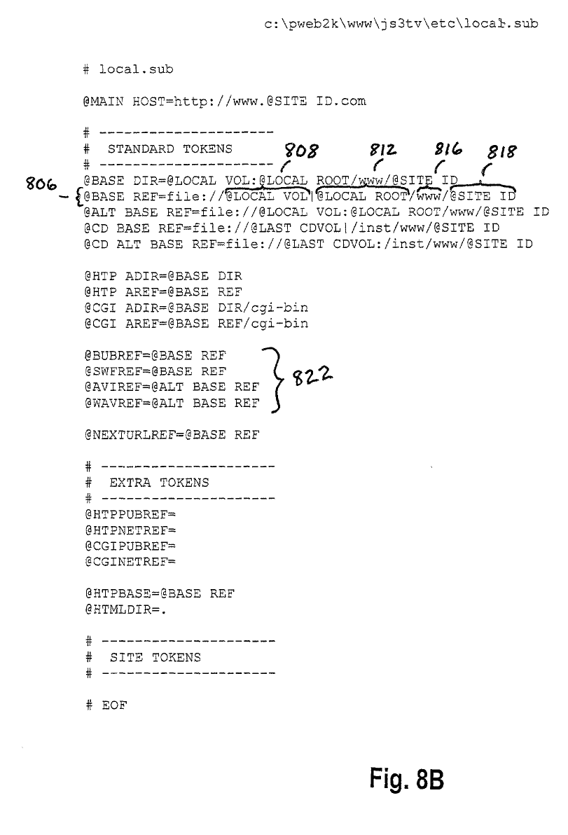

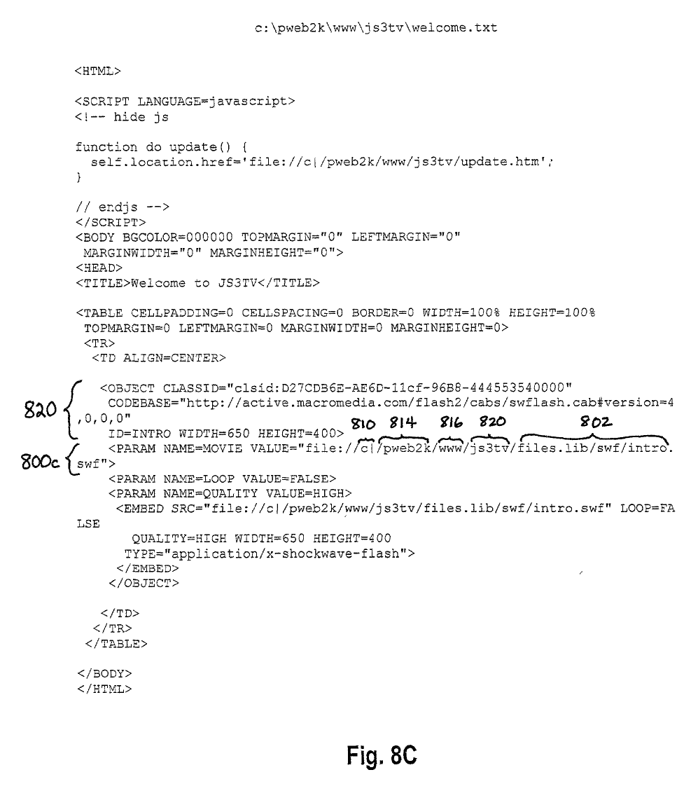

FIGS. 8A-8C illustrate a source file going through the token resolution and instantiation process. FIG. 8A illustrates the source file as written and stored on the primary content server. FIG. 8C illustrates the source file after the tokens have been resolved to the local destination system. FIG. 8B depicts a data file defining token resolution protocols. FIGS. 8A-8C depict many distinct examples of tokens resolution procedures. For one example, the original reference 800a in FIG. 8A has been tokenized and resolved to the local reference 800c in FIG. 8C using the resolution procedure 806 of FIG. 8B. In FIG. 8A the reference 800a has a base (here denoted in shorthand as “!!” 804) and a file name and location 802. The resolution procedure 806 of FIG. 8B indicates that the base “!!” is replaced by a token “@BASE REF.” Accordingly, when the original reference 800a is instantiated to the destination system, the base portion “!!” 804 will be replaced by the resolved token @BASE REF, at it is defined 806. As seen in FIG. 8B, the @BASE REF comprises a series of other tokens, which are instantiated at install time based on the optimum configuration of the destination system. As shown with respect to FIG. 8B & 8C, the base reference (“!!” 804 from FIG. 8A) was replaced with the local volume token 808 instantiated as “c|” 810, the local root token 812 instantiated as “pweb2k” 814, the www folder 816, and the site I.D. token 818 instantiated as js3tv in FIG. 820. Because the remaining portion of the reference 802 as not tokenized in FIG. 8A, that portion also is seen in FIG. 8C unchanged.

Similarly, an entire reference can be left unresolved if desired. Simply by defining token resolution procedures 822, certain resources, such as WAVE files or AVI files can be resolved in one manner, while other items can be resolved in another manner. That is the flexibility provided by the present invention.

Even after content has been optimally installed on a destination system, it typically should be timely to be valuable. Because portable Web site technology uses “as of” dates and other forms of date stamps to provide a means for knowing with certainty which version of any data or content file is current, the present delivery system provides a means of optimizing the connection with the Internet. No data or content file gets transmitted more than once unless the user deliberately removes or alters the file locally. There are varying ways for determining which files are current, and those skilled in the art realize the pros and cons of each method.

The preferred embodiment adopts a date/time “high watermark” approach. If the content on the primary server is newer than the high watermark date for the portable Web site, then the newer information can be transmitted to the destination system to replace or update the old content. The request to verify timeliness of content can be automatic, or it can be initiated by the user of the destination system. As another means of preventing unnecessary transfer of content, when a user requests an update to a portable Web site, the content server first typically locates the date offset that corresponds to the update request in the portable Web site database. The content server then simply transmits the balance of the content to the portable Web site destination system. The content installation module can further ensure that only the appropriate forms or versions of the content are installed. Other methods of determining change in content, such as bit by bit file comparisons, checksums, digital signature, or unique object identifiers could also be used.

Even if the content of the portable Web site does not change at all, there may be situations where reconfiguration or re-installation of the portable Web site would still be desirable. For example, if the user re-configures the local environment, the Web site can be re-instantiated to recognize those changes even if the original content did not change at all. In this manner, the system always operates with an optimum configuration and installation. The variety of elements of the Web site that can be modified to suit a local environment is unlimited.

One of the strengths of the portable Web sites paradigm is that it supports independent downloading and queuing by separating the retrieval of new content from the actual use of the Web site. Most of the time, users of portable Web sites are making no use whatsoever of their Internet connection because the content has already arrived on their desktop and is being served locally. Whenever possible, the preferred embodiment of the present invention downloads information in the background, employing otherwise unused network bandwidth to transfer data. If the destination system is using less than it's full bandwidth capacity, other data can be transferred in the background without the user even knowing it. Larger portions of data can also be downloaded in background after the majority of the site has already been downloaded. That way the user can view as much of the site as possible within a short time frame.

The content transfer module can operate “on its own” without direct input form the user because it can be programmed to optimize the process by which it retrieves data. Users are no longer put in the position of having to decide whether to stop what they are working on and wait for an update. While data transfers are still ultimately limited by the bandwidth available at a given location, the fact that bandwidth speed is never experienced directly by the user changes the entire look and feel of the Web site. The user becomes accustomed to the kind of responsiveness that is typically of a locally installed application. This is precisely because a portable Web site can be a locally installed application.

Once the destination system has received and installed portable Web sites, they are operated with standard Web navigation tools. However, in order to provide optimum efficiency, software con be employed on the destination server to provide an ideal graphical user interface to manage the locally stored content. In the newly defined client-server architectural paradigm defined by the present invention, the majority of the sites the user needs to access are stored locally. In this more efficient model, routinely accessing data over the Internet is made the exception rather than the rule.

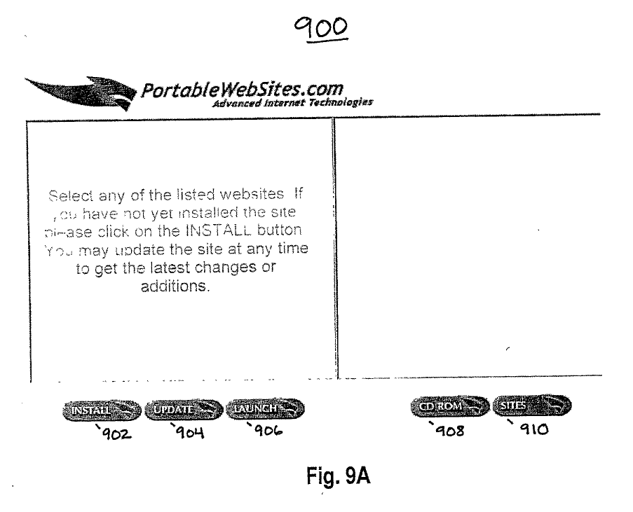

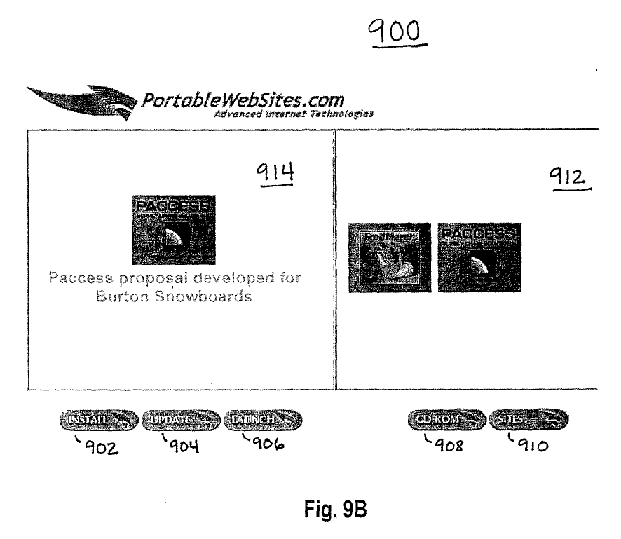

To facilitate such a model, the present invention also includes a local portal to access the portable Web sites. The local portal provides a superior way to manage installations and updates for portable Web sites. FIG. 9A depicts a simplified example of a GUI for the local portal 900. It contains controls to install a site 902, update a site 904, launch a site 906, as well as controls to access CD-ROM information 908 and Site lists 910. FIG. 9B also illustrates the GUI for the local portal 900, but it also illustrates a window 912 showing installed sites and a window 914 showing a site that has been selected by the user. The user can then use the controls 902-910 for desired actions.

While the preferred embodiment has been described above, it should also be noted that many variations on the preferred embodiment are possible while remaining within the scope of the present invention. For example, rather than being operated on the server side, the super-language compiler could be operated on the client side (or anywhere in between). In that configuration, there are small amounts of data passed over the Internet, and the majority of the processing is accomplished away from the server.

Similarly there are many useful applications that naturally fall out of the technology of the present invention and the redefinition of the client-server architecture to capitalize on resources in the mezzanine of the network. Providing Web sites such as multi-media company catalogue that seamlessly integrates with the company's Web server for a current quote, a movie rental company showing high-quality movie trailers, or an actor including video clips of his past performances are some of the more obvious implementations of the present technology. Because resolution of tokens occurs at install time, the actual content or display of the Web site can be dependent on characteristics or needs of the user operating the destination system. For example, tokens could be resolved so as to create a Web site in the native language of a foreign Web surfer. Access to a site can be limited to a certain event, such as supplying an identifying password, or making a concurrent phone call, or using a particular computer or dongle. This could be allowed to secure sensitive data or prevent minors from viewing questionable content. Another user for encryption would be for a stockbroker to deploy decrypted video interviews to Internet service providers who use a distributed mezzanine server to provide secure, metered access and billing information.

Another example of an implementation of the present technology also greatly illustrates the benefit of collaborative files and a hierarchical file management structure such as that supported by the present invention. Imagine a local portal or portable Web site with a GUI resembling a jukebox music player. Perhaps children share music resources but they have not organized their music files. Because the present invention allows install time resolution of tokens, and because they adapt to the configuration of the destinations system, the jukebox Web site can establish links to any folders that have MP3 or other music files. Even if the child is not organized enough to know where he stores those files, an embodiment of the present invention can analyze the system resources and locative files of the desired types. At the same time, the hierarchical file structure and file management and editing aspects of the present invention can allow new files to be saved into a location that makes the most sense for that particular destination system. This same local storage location can then be made available for subsequent downloads of music files (even if from a different portable Web site). Eventually, the system can have many files organized into one area, thus creating a music library.

As a further example of integration, the present invention allows a user to integrate databases with Scan so a local Web sites can interact dynamically with the databases. This provides a method for establishing what, in effect, is a dynamic database.

It will be obvious to those having skill in the art that many changes may be made to the details of the above-described embodiment of this invention without departing from the underlying principles thereof. The scope of the present invention should, therefore, be determined only by the following claims.

1. A method for packaging content comprising a Web site into a relocatable form for installation on a destination system, the method comprising the steps of:
assembling content comprising a Web site;
modifying the content by replacing an absolute reference with a token reference;
transferring the modified content, including the token reference, to a destination system;
installing the modified content on the destination system by resolving the token reference consistent with the destination system configuration.

2. The method of claim 1 wherein the destination location configuration is determined by scanning system resources on the destination system.

3. The method of claim 1 wherein the destination location configuration is determined by receiving input from a user of the destination system.

4. The method of claim 1 further comprising the step of prompting the user of the destination system to identify the desired instantiation of the tokenized references.

5. The method of claim 1 wherein the content comprises source code.

6. The method of claim 5 wherein the source code is chosen from a list consisting of markup language source code, CGI script source code, Javascript source code, Perl source code, Java source code, C/C++ source code, and the like.

7. The method of claim 1 further comprising the step of providing a data file containing a resolution procedure for the token reference.

8. A method for packaging content comprising a Web site into a relocatable form for installation on a destination system, the method comprising the steps of:
obtaining a markup language source code containing an absolute reference to content;
identifying the absolute reference as a candidate for token substitution;
providing a data file containing a token resolution protocol for use in resolving a token;
executing a computer program to bind the content into a portable object, wherein the executing step includes substituting a token for the absolute reference;
transporting the portable object to a destination system for installation on the destination system;
installing the portable object on the destination system;
resolving the token according to the token resolution protocol contained in the data file.

9. The method of claim 8 wherein the transporting step includes transporting the portable object via a portable storage medium.

10. The method of claim 8 further comprising the step of periodically sending a request from the destination system to update the content.

11. The method of claim 8 wherein the installing step and the resolving step are substantially contemporaneous.

12. The method of claim 8 further comprising the step of allowing a user of the destination system to alter the token resolution protocol.

13. A portable Web site system for relocating data and content defining a Web site from a primary content server to a destination system, the portable Web site system comprising:
a development program for gathering content referenced by a Web site;
a data file containing a protocol for resolving a tokenized content reference to the destination location;
a compiler program to tokenize a content reference and bind the content for transport to the destination system; and
an installation program to install the content on the destination system and resolve the tokenized content reference according to the protocol.

14. The system of claim 13, wherein the compiler program is a super-language compiler operable on a text file.
